(19) United States
(12) Patent Application Publication
(10) Pub. No.: US 2018/0025633 A1
(43) Pub. Date: Jan. 25, 2018

(54) ADVANCED ACCESSIBLE PEDESTRIAN SYSTEM FOR SIGNALIZED TRAFFIC INTERSECTIONS

(71) Applicant: Dick Campbell Company, Boise, ID (US)

(72) Inventors: Philip Tate, Boise, ID (US); Zane Sapp, Boise, ID (US); Lucas Wells, Boise, ID (US); Lijun Yang, Boise, ID (US); Josh Meier, Boise, ID (US)

(21) Appl. No.: 15/656,997

(22) Filed: Jul. 21, 2017

Related U.S. Application Data
(60) Provisional application No. 62/364,943, filed on Jul. 21, 2016.

(51) Int. Cl. G08G 1/07; G08G 1/005

(52) U.S. Cl. CPC G08G 1/07; G08G 1/005

(57) ABSTRACT

Pedestrian call systems with bidirectional communication between pedestrian call stations and traffic controllers are arranged so as to detect system errors, to provide the ability for pedestrians to provide input as to the need for the system to provide an opportunity for the pedestrian to cross the intersection, and to provide notification capability in the event of an emergency. Communications are provided via wireless communication devices, and systems can be configured and monitored using a web browser. In one example, traffic systems are provided with wireless interfaces that can be used for bidirectional communication.

### FIELD

The disclosure pertains to traffic control systems, particularly for visually impaired pedestrians that embody wireless communication methodologies between individual components of the communication systems.

### BACKGROUND

Traffic control systems are ubiquitous in modern transportation systems. Traffic control systems are commonly used to regulate the flow of motorized vehicles, non-motorized vehicles and pedestrians on roads, streets, highways, bridges, and other surface transportation media designated for such purposes. Henceforth, the term “roadway” will be used to include any surface transportation media. Traffic control systems use visible indicators to direct when travel is permitted or not permitted on designated roadways. The purpose of traffic control systems is to provide safe and efficient access to the shared roadway for a specified group of roadway users. Crosswalks are portions of the roadway that are allocated for pedestrians to cross one or more roadways. They are identified by painted markings on the roadways and/or signage on the side of the roadway as described in the Manual for Uniform Traffic Controller Devices (MUTCD) which is available at http://muted.fhwa.dot.gov/htm/2003r1r2/html_index.htm.

A traffic control system is comprised of an electronic device that determines which vehicle and pedestrian signals are to be active to control movements through a designated portion of the roadway. As used herein, an intersection refers to the intersection of two or more roadways or other pathway or crosswalk intersection, such as an intersection between a path and a road, the intersection of two roadways, and/or a midblock crosswalk, that share a common right of way in such a manner that one or more traffic movements must be constrained to avoid conflicts that may result in collisions. A signalized intersection is an intersection that uses a traffic control system to control vehicle and pedestrian movements at an intersection or on a roadway. The traffic control system may incorporate sensors that detect the presence of vehicles at specific places in the roadway. The traffic control system may also have detectors to sense when a pedestrians, bicyclist or other traveler presses a button or otherwise signals that they are requesting (calling for) service to be able to cross a specific element of the roadway.

Conventional traffic control systems used today consist of three essential elements: 1) the traffic controller that is responsible for determining which signals are on at any given time and, in some cases, processes sensor inputs, 2) one or more load switches that converts the traffic controller logic outputs to turn on and off supply voltage, and 3) a conflict monitor (CM) or malfunction management unit (MMU) that monitors the outputs from the load switches to ensure safe operation by detecting signals that create a conflict in traffic movements involving vehicles and, in some cases, pedestrians. The CM or MMU places the system into a safe fail mode if a conflict is detected.

Many traffic control systems provide control of pedestrian movements using visible and audible messages and/or symbols. According to the MUTCD, visible signals used to control pedestrian movements include illuminated signals that display the words “WALK”, “DON'T WALK”, and “WAIT.” Other traffic control systems use the illuminated symbol of a walking person in lieu of a “WALK” signal and a symbol of a hand in lieu of the “DON'T WALK” or “WAIT” signals. Some traffic control systems also include countdown timers that display the number of seconds remaining before the pedestrian is to be clear of the segment of the roadway shared with other users. In addition to the visible displays, some traffic control systems also broadcast audible messages in the form of verbal phrases or easily differentiable tones.

Pedestrian movements at signalized intersections are con-trolled by displaying the “WALK” indication indicating that individuals should proceed to cross the designated roadway with due caution. The “WALK” display changes to a flashing “DON'T WALK” indicating that a pedestrian who is not already in the roadway should no longer leave the curb and enter the roadway. A non-flashing “DON'T WALK” display indicates to the pedestrian it is no longer safe to be in the roadway for the designated crossing.

Some pedestrian movements are controlled by the traffic controller that automatically allocates a regular fixed time interval for pedestrian crossings and requires no action by the pedestrian to register a request for service with the traffic controller. Some traffic control systems provide a sequence of displays to both vehicles and pedestrians when triggered by manual push buttons, or other pedestrian friendly features.

A pedestrian call system provides the means for pedestrian to request the traffic controller to provide a WALK indication during the appropriate interval associated with parallel traffic movement or provide an exclusive pedestrian movement. In the case of pedestrian movements combined with parallel vehicle movements, the timing of the vehicle movement may be extended to allow sufficient time for pedestrians to complete the crossing.

Usually the push buttons that are used by the pedestrian to register a request for service with the traffic controller are physically positioned in the proximity of the side of the roadway adjacent to the media used by motorized vehicles. The MUTCD gives guidelines as to the placement and orientation of the pedestrian activation buttons. However, variations of roadway geometries preclude consistent and predictable placement of the pedestrian call buttons at many signalized intersections.

The operation of today's traffic control systems provide a reasonable degree of safety provided that pedestrians and vehicle operators use their sight to identify potential hazards and conflicts as well as to correctly identify the signal lights that are illuminated to control their movements. Pedestrians with cognitive and visual acuity impairments must rely on auditory cues to assist them in lieu of visual signals. The difficulties of crossing a roadway for people with cognitive and vision impairments are described in detail in Harkey et al., “Accessible Pedestrian Signals: A Guide to Best Practices” (hereinafter “Harkey”) available at http://onlinepubs.trb.org/onlinepubs/nchrp/nchrp_w117a.pdf. Harkey's Appendix D (also available at http://www.walkinginfo.org/aps/appendix_d_understanding.cfm) discusses the safety and access difficulties faced by blind pedestrians. Both of these are incorporated herein by reference.

Unfortunately, although the proper operation of traffic signals is essential for safe passage of the visually impaired, pressing a call button merely activates a sequence of intended operations, but no confirmation of appropriate operation is available to the caller. Hence, visually impaired pedestrians rely on proper operation of traffic signaling systems, and cannot readily detect malfunctions. Accordingly, improved traffic control devices and methods are needed that permit visually impaired pedestrians to verify proper operation; in particular improved traffic control devices are needed that utilize wireless communication between individual components of the traffic control device.

### SUMMARY

The advanced accessible pedestrian call system (AAPS) comprises one or more pedestrian call stations (PCSs) located at intersection crosswalks, one pedestrian management units (PMUs) that registers calls to the traffic controller and senses the status of the traffic signal lights and the communications infrastructure that allows wireless exchange of information and controls between the PMU and one or more PCSs. While a PCS can be associated with a fixed call button, as used herein, a PCS is any device, fixed or mobile, that is used to register a pedestrian call with a traffic controller.

A pedestrian call station comprises a pedestrian call switch (typically push button or otherwise configured for a pedestrian to input notification that the pedestrian is at the station) operable in response to a request by a pedestrian and a pedestrian station processor coupled to the pedestrian call switch and configured to communicate via wireless communication a traffic control request to a pedestrian management unit in response to activation of the pedestrian call switch and to receive an acknowledgment of the traffic control request from the pedestrian management processor. In some examples, a network interface is provided and is in communication with the pedestrian station processor, wherein the network interface is coupled to receive the acknowledgment of the pedestrian management processor request and communicate via wireless communication the pedestrian management processor request to the processor. In further examples, the pedestrian station processor is configured to retrieve at least one audio message from a memory at the pedestrian call station and to communicate via wireless communication an identifier associated with the retrieved audio message to a pedestrian management unit. In further examples, the processor is configured to communicate via wireless communication an identifier associated with an audio message volume to the traffic controller. In additional examples, the processor is configured to store an audio message received in the memory and to adjust an audio message volume based on a time of day and or the level of ambient noise. In some examples, a memory is coupled to the pedestrian station processor and operable to store audio messages and tones associated WALK, WAIT, DON'T WALK, beacon destination, and beacon initiation.

A pedestrian management unit (PMU) comprises a pedestrian management processor, an interface with the traffic controller cabinet, and a network interface coupled to the processor. The network interface is operable to receive a traffic control request from one or more pedestrian call stations and/or another traffic control device and to transmit a traffic control request acknowledgment to the pedestrian call station or other traffic control device. Devices such as cell phones and other personal electronics can also be used. In some examples, the logic and processing required by the pedestrian management unit maybe a separated device located outside the traffic controller. In other cases, the logic and processing may be incorporated into the hardware and software of the traffic controller device. In some examples, the pedestrian management processor is operable to determine a traffic signal light status. In additional examples, the network interface is operable to communicate via wireless communication traffic signal light status. In some examples, the network interface is operable to direct at least one audio message to at least one pedestrian station processor.

In other examples, a plurality of pedestrian call stations (PCSs) is provided, and at least one of the pedestrian call stations includes a network interface operable to transmit a pedestrian signal identifier to the pedestrian management processor. In further representative examples, the network interface is operable to receive an audio message and the pedestrian call station includes a memory configured to store the audio message. In other embodiments, the network interface is operable to transmit an audio message identifier to the pedestrian management processor. In additional examples, the pedestrian management processor is operable to send a communication to a second PCS in response to the traffic control request, the communication including an instruction to play a beacon message. In a preferred embodiment the PMU supplies status and a smart PCS reads the status and reacts appropriately, for example by broadcasting an audio signal to pedestrians located in an area proximate to the PCS. The PCS (interchangeably called an APC) able to communicate bi-directionally via wireless communication with an Advanced Pedestrian Button (APB or interchangeably called a Pedestrian Call Button or PCB). In a preferred embodiment each includes a transmitter and receiver, or a transceiver, either separately or as built in functionality of the APC and APB.

In a further preferred embodiment the APC is configured to receive a signal from an external source, such as a central traffic control unit or central authority, alerting the APC to a an external event such as an emergency. The APC will then notify the APBs of the existence of the situation. The notification may contain a directive to the APBs to proceed with emitting a specified warning signal and/or the processor of the smart APB will interpret the signal and act in a programmed response to the signal. For example, in the situation of an Amber Alert, a central traffic control unit, such as a city's traffic control office, may receive notice that an Amber Alert has been issued. The central traffic control unit then will provide notice of the situation to each APC in the area, preferably by a dedicated wireless communication network or by alternative communication network. Each APC then provides notice via wireless communication of the event to the APBs that it is in communication with. This can include a directive to the APBs to emit an audio notification of the Amber Alert, including for example a description of the missing child for whom the Amber Alert has been issued. Alternatively or in addition to receiving a directive to do something, each APB may receive a signal notifying it of the situation and in turn react based on that situation, such as an emergency. Other emergency situations also could be noticed, including but not limited to, a fire, a tsunami, or a flash flood.

Representative PCSs include pedestrian button systems that comprise a pedestrian call switch operable in response to a request by a pedestrian and a processor coupled to the pedestrian call switch and configured to communicate via wireless communication a traffic control request to a traffic controller in response to activation of the pedestrian call switch and to receive an acknowledgment of the traffic control request from the traffic controller. In some examples, a network interface is provided and is in communication with the processor, wherein the network interface is coupled to receive the acknowledgment of the traffic control request and communicate via wireless communication the traffic control request to the processor. In further examples, the processor is configured to retrieve at least one audio message from a memory at the pedestrian button system and to communicate via wireless communication an identifier associated with the retrieved audio message to a traffic controller. In further examples, the processor is configured to communicate via wireless communication an identifier associated with an audio message volume to the traffic controller. In additional examples, the processor is configured to store an audio message received in the memory and to adjust an audio message volume based on a time of day. In some examples, a memory is coupled to the processor and operable to store audio messages associated WALK, WAIT, DON'T WALK, beacon destination, and beacon initiation.

Traffic control systems comprise a pedestrian management processor and a network interface coupled to the processor. The network interface is operable to receive a traffic control request from a traffic control device and to transmit a traffic control request acknowledgment to the traffic control device. In some examples, the pedestrian management processor is operable to determine a traffic control status. In additional examples, the network interface is operable to communicate via wireless communication traffic control system parameters. In some examples, the network interface is operable to direct at least one audio message to at least one traffic signal. In other examples, a plurality of accessible pedestrian signals is provided, and at least one of the accessible pedestrian signals includes a network interface operable to transmit a pedestrian signal identifier to the pedestrian management processor. In further representative examples, the network interface is operable to receive an audio message and the accessible pedestrian signal includes a memory configured to store the audio message. In other embodiments, the network interface is operable to transmit an audio message identifier to the pedestrian management processor. In additional examples, the pedestrian management processor is operable to send a communication to a second traffic control device in response to the traffic control request, the communication including an instruction to play a beacon message. In a preferred embodiment the pedestrian management unit is configured to receive a signal from traffic control sensors, including those provided by third party manufacturers, to generate requests and actions from the traffic controller.

Traffic control methods comprise generating a call for service from a traffic control device, typically a PCS in response to a pedestrian request and communicating the call for service to a traffic controller. The status of the traffic signal lights is to be received at the pedestrian call station and an audio message associated with the requested service at the traffic control device is played. A verification that the audio message is being played is transmitted to the traffic controller. In further examples, a destination associated with the requested service is determined, and a second beacon message is provided to a second PCS that is associated with the destination and stored in a memory at the destination PCS. The second beacon message is played by the PCS associated with the destination after the requested service and only during the time that is associated with the assigned pedestrian movement. In other examples, a time of day is determined, and a volume for the audio message is established based on the time of day. In other examples, a time of day is determined, and a volume for the audio message is established based on the ambient audible noise.

The data transmitted over the network between the PCSs and the PMU can use any proprietary or open communications protocol. In one example, the WiAAPS employs a protocol standard that is compliant with the National Transportation Communications for Intelligent Transportation Systems Protocol (http://www.ntcip.org/).

Traffic control methods comprise generating a call for service from a traffic control device, typically a PCS in response to a pedestrian request and communicating the call for service to a traffic controller. The status of the traffic signal lights is to be received at the pedestrian call station, and an audio message associated with the requested service at the traffic control device is played. A verification that the audio message is being played is transmitted to the traffic controller. In further examples, a first beacon message is provided to the traffic control device and is played at the traffic control device after the requested service is authorized. A verification that the beacon message has been played is transmitted to the traffic controller. In other examples, a destination associated with the requested service is determined, and a second beacon message is provided to a traffic control device associated with the destination and stored in a memory at the destination traffic control device. The second beacon message is played at traffic control device associated with the destination after the requested service is authorized. In other examples, a time of day is determined, and a volume for the audio message is established based on the time of day.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic block diagram of a representative Advanced Accessible Pedestrian System (AAPS).

FIG. 2 is a schematic block diagram of another representative Advanced Accessible Pedestrian System (AAPS).

FIG. 3 is a schematic block diagram of a representative Pedestrian Management Unit (PMU).

FIG. 4 is a schematic block diagram of a representative Pedestrian Call Station (PCS).

FIG. 5 is a schematic block diagram of a representative protocol stack.

FIG. 6 is a schematic block diagram illustrating messaging between an SNMP Agent and an SNMP Manager.

FIG. 7 is a schematic block diagram illustrating messaging between a Pedestrian Management Unit (PMU) and a plurality of Pedestrian Call Stations (PCSs).

FIG. 8 is a schematic block diagram illustrating a pedestrian call from a PCS and an acknowledgment from a pedestrian management unit (PMU).

FIG. 9 is a schematic block diagram illustrating an audio update message from a PCS to a PMU.

FIG. 10 is a schematic block diagram illustrating initiation of WiAAPS operation.

FIG. 11 is a schematic block diagram illustrating determination of pedestrian signal status.

FIG. 12 is a schematic block diagram of a representative procedure for sending call requests from a PCS to a traffic controller.

FIG. 13 is a schematic block diagram of a representative error diagnostics procedure.

FIG. 14 is a schematic block diagram of a representative method of processing a pedestrian call.

FIG. 15 is a schematic block diagram of a representative beaconing procedure.

FIG. 16 is a schematic block diagram illustrating a standard pedestrian call.

FIG. 17 is a schematic block diagram illustrating an APS call.

FIG. 18 is a schematic block diagram of a representative procedure for fault processing.

FIG. 19 is a perspective view illustration of the interaction between an APC located in a traffic control cabinet and a APB configured for wireless communication.

FIG. 20 is a perspective view illustration of the interaction between an APC located in a traffic control cabinet and a plurality of APBs in a network of APBs.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” means electrically or electromagnetically coupled or linked and does not exclude the presence of intermediate elements between the coupled items. Such coupling can be based on physical connections such as wired connections, or wireless connections based on, for example, optical, infrared, or radiofrequency communications.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed the actual operations that correspond to these terms will vary depending on the particular implementation and are readily discernible by one of ordinary skill in the art.

Specific communication protocols, traffic signal configurations, and other details are described in the following examples for convenient illustration. In other examples, different communication protocols, traffic signal configurations, electronic components and groupings can be used. In the disclosed examples, reference is made to software objects which can include constant and variable data values, functions, and procedures that are implemented in series of computer-executable instructions that can be stored in memory, on hard drives, flash drives, or other computer readable media. Computer systems such as personal computers (desk-tops and laptops), networked computers and dumb terminals, palm tops, smart phones, or other computing devices can be used to execute such instructions. Alternatively, dedicated processors can be used. System components that are illustrated as separate can be combined, and single components that provide multiple functions can be implemented with two or more components.

In many examples, reference is made to messages or communications that are transmitted between system components. Such messages are typically delivered as modulated voltages or currents, or optical beams. Typically such messages or communications are encoded digitally, but analog or other formats can also be used.

### Terminology

For convenience, descriptions of some terms used in the disclosure are provided herein.

MUTCD-Manual for Uniform Traffic Controller Devices: A traffic intersection-a location where vehicular traffic going in different directions can proceed in a controlled manner designed to minimize accidents.

Signalized intersection: A traffic intersection consisting of two or more streets where the vehicular and non-vehicular traffic is managed using an automated electronic controller.

Traffic controller: A computer based device that uses a program to process inputs generated by electronic timers, in situ instrumentation or manually operated electric switches to generate outputs that control the state of visual and audible signals to control movements of vehicles, people, bicycles, and other human operated devices that move through the intersection under control.

Traffic controller cabinet: An equipment cabinet used to contain the traffic controller and other electrical and mechanical devices required to interface the traffic controller with input and output circuits and devices. The traffic controller cabinet is generally physically located in close proximity to the corners of the intersection.

Malfunction Management Unit (MMU): An independent electronic device used with NEMA TS2 traffic controllers that monitors all traffic signal outputs from traffic controller cabinet to detect a malfunction or a conflict in operations.

Conflict Monitor (CM): An independent electronic device used with NEMA TS1 traffic controllers that monitor all traffic signal outputs from traffic controller cabinet to detect a malfunction or a conflict in operations.

Accessible Pedestrian Signal (APS): A device that communicates information via wireless communication about pedestrian timing in non-visual format such as audible tones, verbal messages, and/or vibrating surfaces as defined by the MUTCD.

Advanced Accessible Pedestrian Signal (AAPS): Advanced accessible pedestrian signal is a generic name of systems such as those described herein.

Pedestrian call: A pedestrian call or request for service is normally placed on current traffic controller installations when button is pressed that is located at one of the corners of the intersection. The pedestrian button completes a circuit that places a low impedance electrical path on the assigned pedestrian input in the traffic controller cabinet.

Initiation point: The physical place associated with a signalized intersection where the pedestrian places a call for service.

Destination point: The physical place associated with a signalized intersection where the pedestrian intends to travel.

Phase: A specific movement of vehicles or pedestrians through a signalized intersection.

Walk phase: The interval during which a WALK signal is illuminated for a particular pedestrian crossing.

Pedestrian clearance phase: The interval during which a WAIT signal is flashing for a particular pedestrian crossing.

Beaconing (also known as target beaconing): A term used to describe the concept of generating audible navigational cues to help visually impaired pedestrians. This is accomplished by generating a distinguishable audible signal at both the initiation and destination points.

Protocol stack: A set of network protocol layers that work together. The OSI Reference Model that defines seven proto-col layers is often called a stack, as is the set of TCP/IP protocols that define communication over the internet. The term stack also refers to the actual software that processes the protocols.

SNMP manager: A system, software part of a system used to control and monitor the activities of network hosts using SNMP.

Agents: Agents are software modules that reside in network elements. They collect and store management information such as the number of error packets received by a network element.

Managed object: A characteristic of something that can be managed. For example, a list of currently active TCP connections in a particular host computer is a managed object. Managed objects differ from variables, which are particular object instances.

A managed device: A network node that contains an SNMP agent and that resides on a managed network. Managed devices collect and store management information and make this information available to NMSs using SNMP. Managed devices, sometimes called network elements, can be any type of device including, but not limited to, routers, access servers, switches, bridges, hubs, IP telephones, computer hosts, and printers.

A network management system (NMS): A collection computer-based network connected devices that executes application software that monitor and control managed devices. NMSs provide the bulk of the processing and memory resources required for network management. One or more NMSs may exist on any managed network.

Management information base (MIB): A collection of managed objects residing in a virtual information store. Collections of related managed objects are defined in specific MIB modules.

GET REQUEST: Used to retrieve a piece of management information.

GETNEXT REQUEST: Used iteratively to retrieve sequences of management information.

GET RESPONSE: Used by the agent to respond with data to get and set requests from the manager.

SET REQUEST: Used to initialize and make a change to a value of the network element.

TRAP: Used to report an alert or other asynchronous event about a managed subsystem. In SNMPv1, asynchronous event reports are called traps while they are called notifications in later versions of SNMP. In SMIv1 MIB modules, traps are defined using the TRAP-TYPE macro; in SMIv2 MIB modules, traps are defined using the NOTIFICATION-TYPE macro.

Example Hardware Implementations

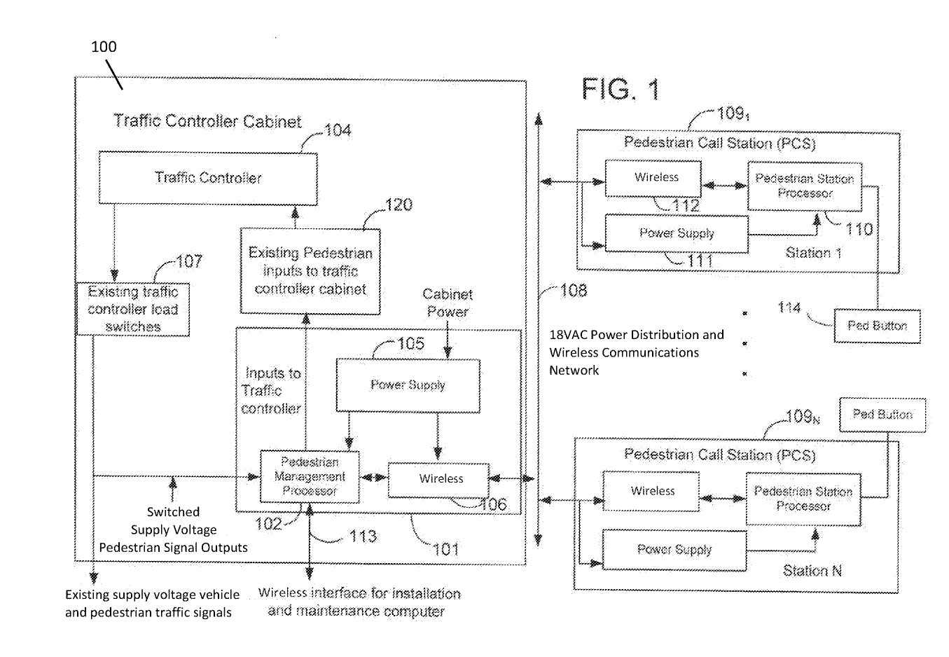

With reference to FIG. 1, a representative Wireless Advanced Accessible Pedestrian System (WiAAPS) includes Traffic Control Cabinet (TCC) 100 in typically wired communication (via Ethernet) with the Pedestrian Management Processor (PMU or APC). The Pedestrian Management Processor is in wireless communication with Pedestrian Call Stations (PCSs) 109₁-109_{N}. The PCSs send via wireless communication notification to the PMU the occurrence of a pedestrian activating the PCS. The PCS communicates the signal and/or commands to the remainder of the TCC via wired connection, specifically Ethernet. The wireless communication with the TCC 100 via a power bus 108 that is configured to provide power or to the PCSs 109. The TCC 100 includes a Traffic Controller 104, typically equipped with traffic controllers that conform to NEMA TS1 or TS2 protocols, or other suitable protocols, a Pedestrian Management Unit (PMU) 101 comprising a Pedestrian Management Processor (PMP) 102, a WiAAPS power supply 105, and a wireless communication interface 106. The wireless communication interface 106 generally includes a coupler and a transceiver so that wireless electrical signals can be transmitted to receivers or transceivers associated with other components of the system. Typically, the PMU 101 and the traffic controller 104 are connected via one or more wireless communication mechanisms. The traffic controller 104 is typically wirelessly coupled to one or more load switches 107 that are configured to operate associated vehicle and pedestrian control signals. The PMP 102 is wirelessly coupled to the one or more load switches 107 so as to receive indications of pedestrian signal output status for one or more pedestrian signals. In some examples, load switch status is buffered by one or more buffer amplifiers or otherwise processed so as to control signal amplitude, digitize, or otherwise filter or process for delivery to the PMP 102.

A wireless or wired interface is configured for coupling to an external computer such as a laptop, desktop, or other portable, fixed, or networked computer that can be used to monitor system status and performance, to install or uninstall hardware and software, adjust various system settings, and configure additional pedestrian call stations. Thus, maintenance and installation can be accomplished with readily available computer hardware and software. In one example, the wireless interface can be configured to communicate via wireless or wired communication with the external computer using a web browser and one or more web pages as will be illustrated below. The PCSs 109 generally include wireless interfaces 112, power supplies 111, and a pedestrian call processor 110. The pedestrian call processors 110 are coupled to corresponding pedestrian buttons 114. Upon activation of a pedestrian button 114, the associated pedestrian call processor initiates a communication to the PMU 101 using wireless communication, including but not limited to WiFi or any other wireless communication methodology. In turn, the PMU 101 initiates a request for service to the traffic controller 104, typically using the PMP 102 to establish a low impedance path on at least one traffic controller input 120. Typically the PMU communicates with the TCC via Synchronous Data Link Control (SDLC). In a typical installed system, two PCSs are provided on opposite sides of a crosswalk. PCSs can be configured to include traffic signals or traffic signals can be provided separately.

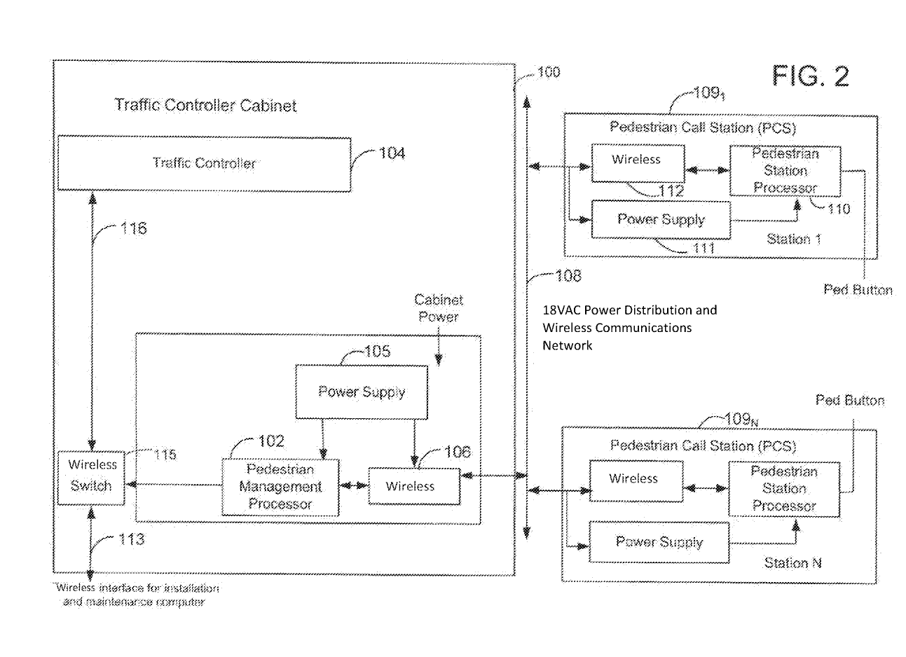

Referring to FIG. 2, in an alternative system to that of FIG. 1, the wireless or wired (Ethernet) communication interface 113 is coupled so that the PMU 101 can communicate via communication 116 with the traffic controller 104. Such a system can be convenient for traffic controllers that include connections that are compliant with National Transportation System for Communications ITS Protocol (NTCIP) standards. The interface 113 can include a switch or hub 115 connected to the communicator to facilitate a connection 113 via a web browser to an external computer for maintenance and installation. Typically, the PMU 101 is configured to detect a wireless signal emitted from the traffic controller 104 and to either connect when prompted or automatically.

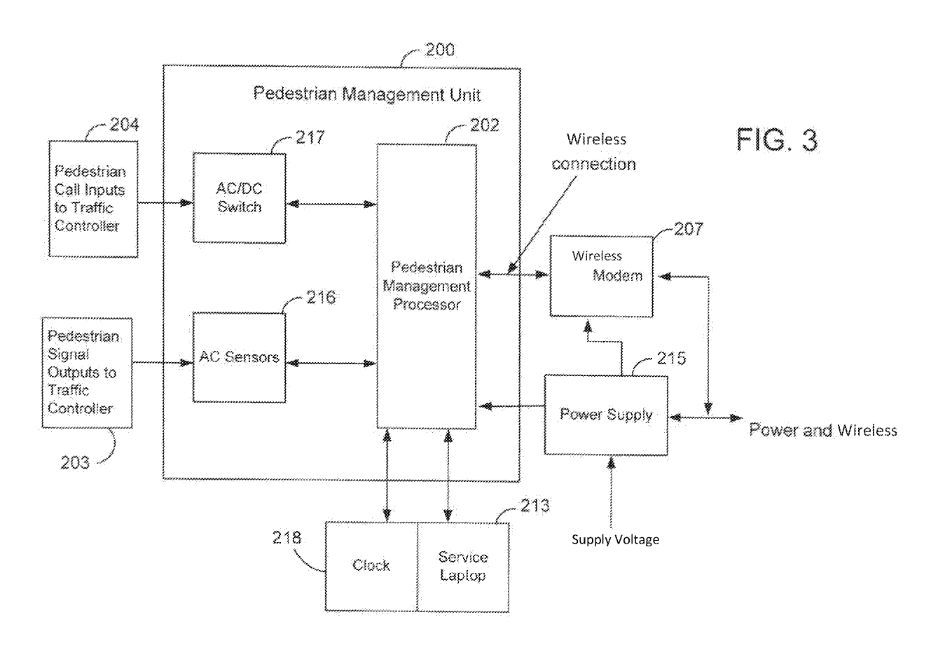

A representative PMU 200 is illustrated in more detail in FIG. 3. The PMU 200 includes a pedestrian management processor 202 that is coupled to one or more AC/DC switches 217 and one or more AC sensors 216 using, for example, serial communications based on the I²C protocol or other suitable processor input/output mechanism. The AC/DC switches 217 are configured to be coupled to one or more pedestrian call inputs 204 and the AC sensors 216 are configured to be coupled to one or more pedestrian signal outputs 203. The processor 202 can also be coupled to an Wireless Interface 207, a power supply 215, and a clock 218 such as a battery operated clock or a WWVB receiver so that current time is available. The availability of current time can be convenient for signal operation that varies as a function of time of day. In addition, the processor 202 is configured for wireless coupling to an external computer such as a service lap top 213 via a web browser interface.

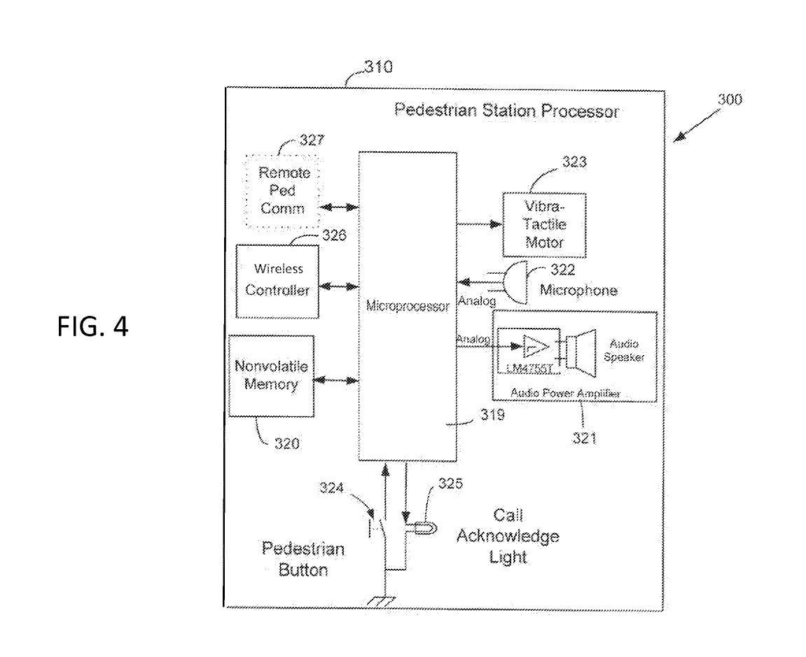

With reference to FIG. 4, a representative PCS 300 includes a pedestrian call processor (PCP) 310, an Wireless Interface 312, and a power supply 311. The PCP 310 includes a microprocessor 319 that is coupled to a vibro-tactile motor 323, a microphone 322, and an audio output 321 that includes an audio amplifier and a speaker. A wide variety of processors can be used. A pedestrian button 324 and an associated call acknowledgment light 325 are also coupled to the processor 319. The processor 319 is also configured to communicate via wireless communication with a remote pedestrian button communication interface 327 that can communicate via wireless communication with a remote or mobile pedestrian button. Nonvolatile memory such as EEPROM can be provided as one or more memory chips 320, or memory can be provided in the processor 319. Typically a unique PCS identifier is stored in the memory, and the PCS identifier can be transmitted wirelessly to a traffic controller or a pedestrian management system (PMS) so that the source of a particular pedestrian call can be identified.

Representative Software Implementations

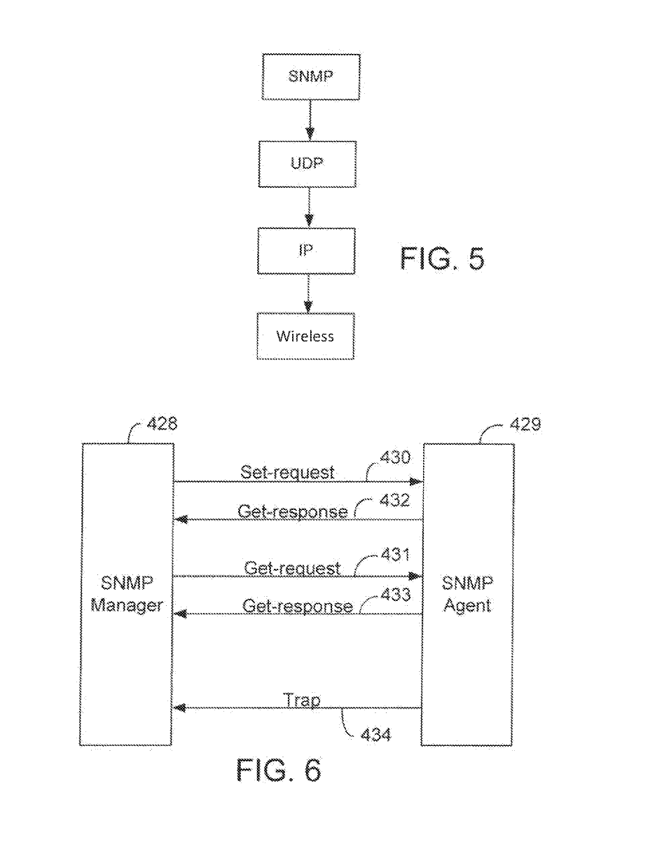

WiAAPS hardware permits a variety of traffic control functions to be implemented using networked communications among various functional units. Generally, all PCSs and PMUs can function based on a Simple Network Management Protocol (SNMP) in which the PMU is an SNMP manager that is configured to make control decisions. PCSs are SNMP agents that are controlled by one or more managers. A representative SNMP software stack is illustrated in FIG. 5. Messages between managers and agents can be exchanged and parameters set, modified, and retrieved in a network, preferably in a network facilitated by wireless communication. If available, such messaging and the like can be implemented based on an existing set of commands and parameters, or a dedicated new set of messages and commands can be implemented. Some details of software used in WiAAPS implementations are described below, but the technology is not limited to a particular implementation.

Object Identifiers

Object Identifiers that can used in operation of a WiAAPS are described in the following tables. Phase Status Node objects (Table 1) are sent from the PMU to each pedestrian station (PCS) at regular intervals. Station Status Node objects (Table 2) are sent from the PCS to the PMU as their values change. The Station Trap objects (Table 3) contain objects sent from the PCS to the PMU as they occur, but additional information can be added. The PCS modifies the value of either Phase Status Calls or APS Calls OID depending on the type of input detected from the user of the button to the trap message. Each PCS can use its preconfigured Station Phase OID value in the value field of this OID. Configuration OID variables (Table 4) are configured once, unlike Status objects, and therefore these objects are saved to nonvolatile memory upon a set of the Station Commit to NVMEM object. Each PCS is initially programmed with default values for each object. The default values allow a new button to be found when added to the network.

TABLE 1
Phase Status OID definitions

| Node | OID | Type | Descriptions |
|---|---|---|---|
| pcs device | 1.3.1.4.1.1206.4.2.14 | Bits | Root node for PCSs |
| node Phase | pcs.2.1 | | Bits. If set to 1 that |
| Status | | | phase is in the don't |
| Don't Walks | | | walk state |
| Phase status | pcs.2.2 | Bits | Bits. If set to 1 that |
| Ped Clears | | | phase is in the Ped |
| | | | clear state |
| Phase Status | pcs.2.3 | Bits | Bits. If set to 1 that |
| Walks | | | phase is in the |
| | | | Walk state |
| Phase Status | pcs.2.4 | Bits | Bits. If set to 1 that |
| Calls | | | phase has a call |
| | | | pending |
| Phase Status | pcs.2.5 | Bits | Bits. If set to 1 that |
| APS Calls | | | phase has an APS |
| | | | call pending |
| Phase Status | pcs.2.6 | Bits | The source of an |
| Beacon Source | | | APS call |
| Phase Status | pcs.2.7 | Bits | The Destination of |
| Beacon | | | an APS call |
| Destination | | | |
| Phase Status | pcs.2.8 | OS | Octet string containing |
| Block Object | | | all of the phase status |
| | | | objects |

TABLE 2
Station Status OID Definitions

| Node | OID | Type | Description |
|---|---|---|---|
| pcs device | 1.3.1.4.1.1206.4.2.1.4 | Bits | Root node for APBS |
| node Phase | pcs.3.1 | Bits | Bits. If set to 1 that phase |
| Status Don't | | | is in the don't walk state |
| Walks | | | |
| Phase status | pcs.3.2 | | Bits. If set to 1 that phase |
| Ped Clears | | | is in the Ped clear state |

TABLE 3
Station Trap OID definitions

| Node | OID | Type | Description |
|---|---|---|---|
| Device OID | 1.3.6.1.6.3.1.1.4.1 | OID | SNMP Tmp OID |
| Phase Status Calls | pcs.2.4 | Bits | Bits. If set to 1 that |
| | | | phase has a call pending |
| Phase Status APS | pcs.2.5 | Bits | Bits. If set to 1 that |
| Calls | | | phase has an APS call |
| | | | pending |
| Station Audio | pcs.3.1 | Int | Audio Message Number |
| Message | | | |
| Station State | pcs.3.2 | Int | Station State Number |

TABLE 4
Configuration OID definitions

| Node | OID | Type | Description |
|---|---|---|---|
| pcs device node | 1.3.1.4.1.1206.4.2.14 | Int | Station ID number. Values 1- |
| Station ID | pcs.1.1 | | 16 (0 for not configured) |
| Station Night Mode | pcs.1.2 | Int | 1 If night mode is on |
| Station Day Locator Volume | pcs.1.3 | Int | Values 0-100 |
| Station Day Speech Volume | pcs.1.4 | Int | Values 0-100 |
| Station Night Locator Volume | pcs.1.5 | Int | Values 0-100 |
| Station Night Speech Volume | pcs.1.6 | Int | Values 0-100 |
| Station IP Address | pcs.1.7 | OS | 4 byte octet string of the |
| | | | stations IP address |
| Station Mode | apb.1.8 | Int | 0-4 AAPS operation Mode |
| Station Identify | pcs.1.9 | Int | 0 for identify off. 1 for LED |
| | | | blink/vib |
| Station Phase | pcs.1.10 | Bits | Bit corresponds to Station's |
| | | | phase |
| Station Group | pcs.1.11 | Bits | Bit corresponds to Station's |
| | | | Group |
| Station Beacon Mode | pcs.1.12 | Int | AAPS Beacon operational |
| | | | Mode |
| Station Commit to NVMEM | pcs.1.13 | Int | 1 saves to configuration to |
| | | | non-volatile memory |

Representative WiAAPS messaging is illustrated in FIG. 6. An SNMP manager 428 (e.g., a PMU) is configured to send a Set-Request command 430 or a Get-Request command 431 to an SNMP agent 429 (e.g., a PCS) and the agent responds to both requests with a Get-Response message 432 or 433. The agent 429 can also send an unsolicited Trap message 434 to a manager to indicate that a variable value at the agent has changed. WiAAPS variable values can be stored in a database which defined by Management Information Base (MIB). Some system variables are specified by the National Transportation System for Communications ITS Protocol (NTCIP). Other systems variables conform to the NTCIP format for custom variable that allow the additional vendor specific variables. Such custom variables are required whenever the necessary variables are not defined by the NTCIP. Selected variables received from the phase StatusGroupEntry objects and associated with signal phases and pedestrian service calls are listed in Table 4. Typically, a PMU collects data regarding pedestrian crossing states and rebroadcasts this data to the PCSs. If a connection to the traffic controller is unavailable, the PMU establishes variable values using inputs that are generally hardwired to traffic controller outputs. While the variables of Table 5 can be used in the disclosed systems, additional WiAAPS functionality can be provided based on additional traffic controller variables such as those listed in Table 6. The phaseStatusGroupAPSCall object is used to track pedestrian initiated calls, the groupStatusGroupAPSBeaconSource object specifies which specific button at the intersection originated the WiAAPS call, the groupStatusGroupAPSBeaconDestination object specifies a user destination, theAPSnightMode object is associated with setting one or more PCSs into a night mode in which audio volume is reduced, and a button Status APSAudioMessage object indicates which audio message (see Table 7) a specific PCS is currently playing. Audio messages can be of arbitrary length subject to memory limitations, and are indicated as shown in Table 7 by a single decimal digit. In other examples, more or fewer messages can be provided. A particular audio message can be selected from a service computer and can be loaded into the WiAAPS, using a web browser interface. Messages can be communicated to and stored at one or more of the PCS. A web interface including a wireless web interface is convenient, and audio messages (audio files) can be transferred using ftp or other transfer media such as HTML multipart form data format which is described below. Table 8 lists several WiAAPS configuration options.

TABLE 5
phaseStatusGroupEntry variables

| Variable | Description |
|---|---|
| phaseStatusGroupWalks | Pedestrian Walk Symbol Status |
| phaseStatusGroupDontWalks | Pedestrian Don't Walk Symbol Status |
| phaseStatusGroupPedClears | Pedestrian Flashing Don't Walk |
| | Symbol Status |
| phaseStatusGroupPedCalls | Pedestrian Call Request Status |

TABLE 6
Custom MIB objects used by the AAPS

| Variable | Description |
|---|---|
| phaseStatusGroupAPSCalls | AAPS Call Request Status |
| groupStatusGroupAPSBeaconSource | Origin of AAPS request |
| groupStatusGroupAPSBeaconDestination | Destination of AAPS request |
| APSnightMode | AAPS night mode operation |
| buttonStatusAPSAudioMessage | Current audio message |
| | playing |

TABLE 7
Audio Messages

| Audio Message | |
|---|---|
| Number | Description |
| 1 | Locator Tone |
| 2 | Wait message |
| 3 | Chirp |
| 4 | Cuckoo |
| 5 | Location Message |
| 6 | Acknowledgement |
| 7 | Clearance |
| 8 | Beacon message |
| 9 | Custom |

TABLE 8
AAPS User Configuration Options

| Setting | Description |
|---|---|
| Base audio volume | Audio message volume before |
| | ambient noise compensation |
| Pedestrian phase | Which pedestrian phase a specific |
| | PCS belongs |
| APS group | Used to associate PCSs with each |
| | other for AAPS source and |
| | destination beaconing |
| APS hold | Amount of time the user must hold |
| | the button on the PCS |
| | before it is considered an AAPS call |
| APS group beacon type | PCS beaconing chirp or cuckoo per |
| | APS group |
| Night time mode | Time of day when PCSs should |
| | operate in night mode |
| Output mode | PCS audio/vibrotactile output for |
| | each pedestrian signal state (walk, |
| | clear, don't) |
| Beacon enable | Enable or disable PCS APS source |
| | and destination beaconing |

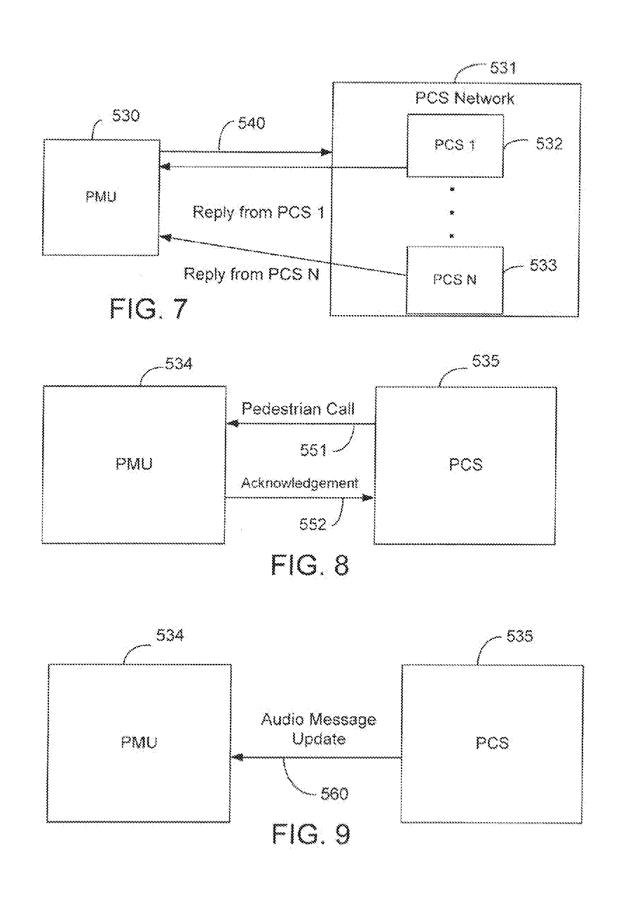

FIGS. 7-9 illustrate WiAAPS communications between a PMU and one or more PCSs. Referring to FIG. 7 a PMU 530 transmits a message 540 to a PCS network 531 to update each with a current state of pedestrian signals. The PMU 530 rebroadcasts such a message including pedestrian signal state, pedestrian requests, day or night mode, and APS call information periodically (in one example, about every 250 ms) to all PCSs. Each PCS such as representative PCSs 532, 533 respond to the PMU 530. If a particular PCS does not respond, the PMU 530 reports the lack of response, and the WiAAPS can signal a traffic controller of a malfunction.

FIG. 8 illustrates communication of a pedestrian call message 551 from a PCS 535 to a PMU 534, and an acknowledgment message 552 sent in response by the PMU 534. The acknowledgement message 552 can be an explicit message or contain the information in the next scheduled status update. The acknowledgement can include current state of responses to pedestrian requests so that the PCS 535 can play the correct audio message at an appropriate time.

FIG. 9 illustrates an audio update message 560 that is transmitted from the PCS 535 to the PMU 534. The message 560 indicates which message is playing. Typically, if a permissive message is being played (“walk light is on”) the PMU 534 is notified periodically at about once per second. For other messages, periodic updates may be used, but the PMU 534 is notified only when the message is changed.

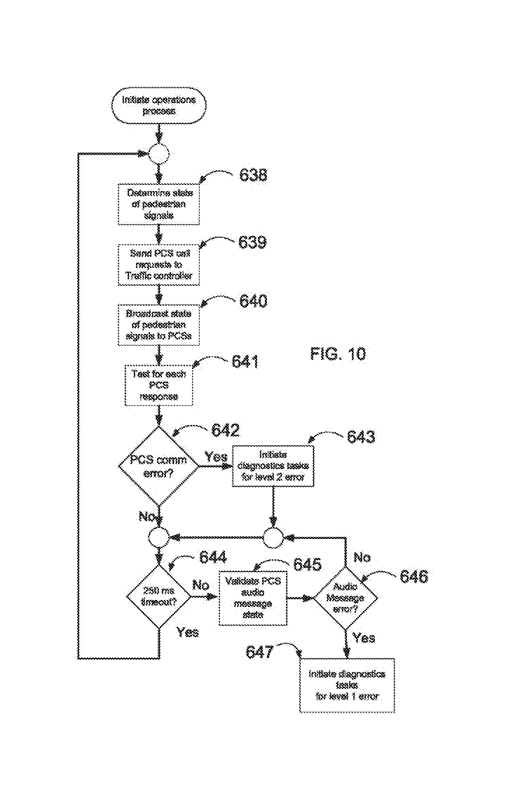

FIGS. 10-18 are functional block diagrams that illustrate operation, maintenance, and diagnostics for an WiAAPS. Typical operation is illustrated in FIG. 10. In a step 638, the state of pedestrian signals is determined, and in step 639 one or more PCS call requests is communicated to the traffic controller. In a step 640, the status of pedestrian signals is broad-cast to the PCSs, and in a step 641, a determination is made as to whether or not the PCSs have responded appropriately. If an error is detected in step 642, diagnostics are initiated in a step 643. As described herein, a loss of communication is referred to as a “level 2” error. Errors that pose more serious safety risks are referred to as “level 1” errors. If a PCS does not respond, the PMU records the loss of communication and continues to operate. If a communication error is not detected, in step 644 a time out determination is made. If a predetermined time (for example, for a pedestrian crossing) has not elapsed, a current PCS audio message is verified in a step 645. An audio error determination is made in a step 646, and diagnostics initiated in a step 647 if an audio error is detected.

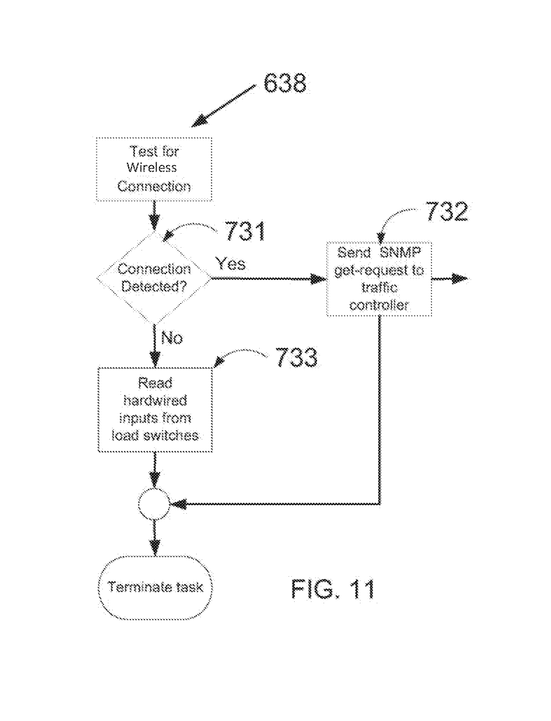

Referring to FIG. 11, the step 638 of determining pedestrian signal states includes a step 731 of determining whether a connection is available. If so, in step 732 a SNMP get-request is sent to the traffic controller using the connection demonstrated in FIG. 2 to update the variables listed in Table 1. If a connection is unavailable, in a step 733 hardwired inputs are interrogated to determine signal states. If the traffic controller outputs are interrogated due to the unavailability of a connection, variable values for variables such as those listed in Table 1 are updated.

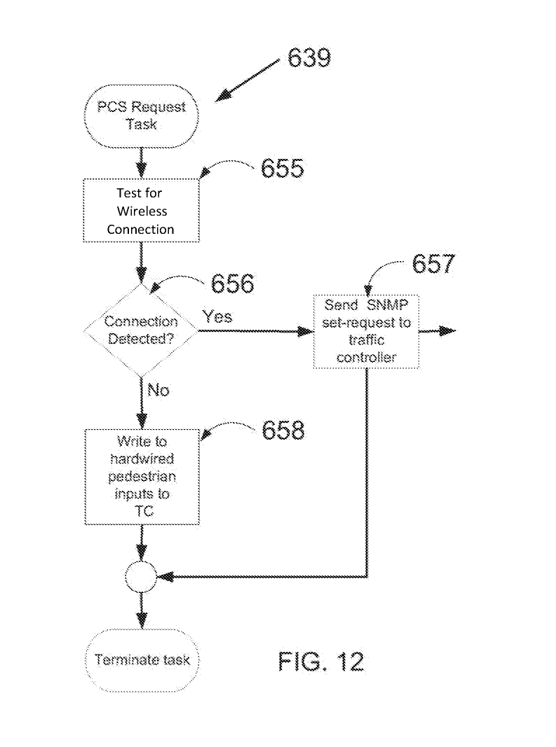

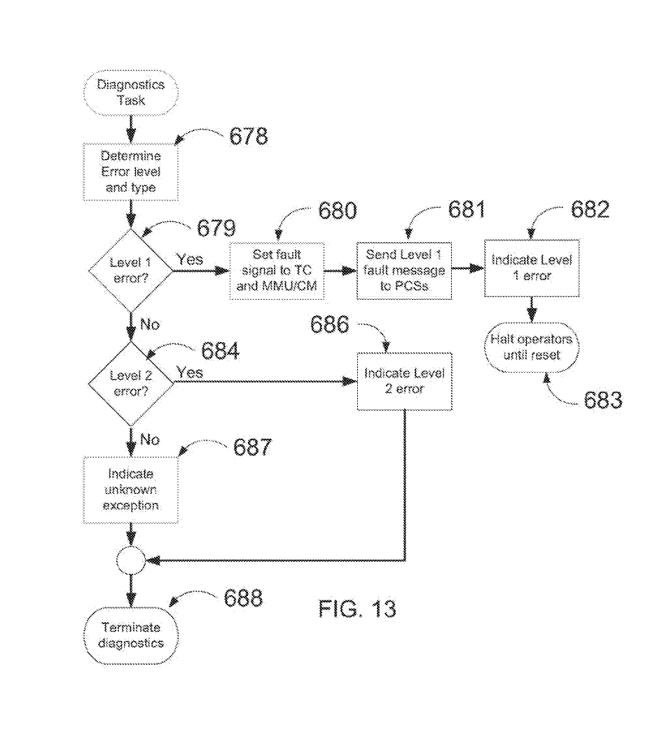

Referring to FIG. 12, the step 639 of sending call requests to the traffic controller includes a step 656 of determining if there is an available connection (typically wireless) and if so, in a step 657 sending an SNMP set-request to the traffic controller. If such a connection is unavailable, a request is initiated via a hardwired output to the traffic controller inputs in a step 658. A representative diagnostic method is illustrated in FIG. 13. In a step 678, an error level or type is determined. In a step 679, detection of a level 1 error initiates a sequence that 15 include sending a set fault signal to a traffic controller and MMU/CM in a step 680 and a fault message to the PCSs in a step 681. As described herein, a level 1 error is any error that is indicative of an unsafe operating condition (for example, playing an incorrect audio message, or otherwise indicating safe passage without proper traffic signal control). In a step 682, audio messages are disabled in a step 683, and operation is halted until manually reset in a step 683. In a step 684, level 2 errors are detected, and an indication of such an error is generated in a step 686 as a message on an LCD or LED array, or other suitable display device, typically by indicating which PCSs are not communicating. For other errors, error codes can be indicated in step 687, but the WiAAPS continues to operate. In a step 688, diagnostic procedures are terminated. Errors can be divided into various groupings, and responses to the various groupings tailored as desired, and the use of only level 1 and level 2 errors is for illustration only.

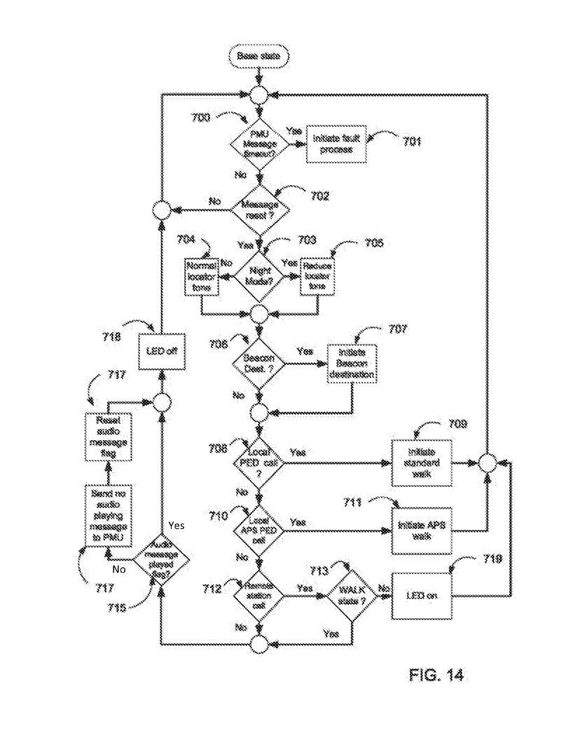

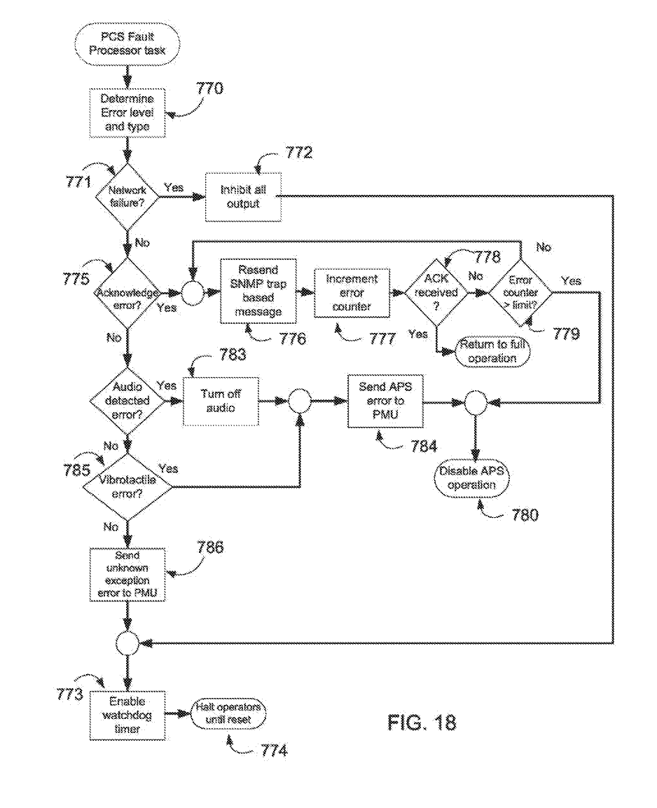

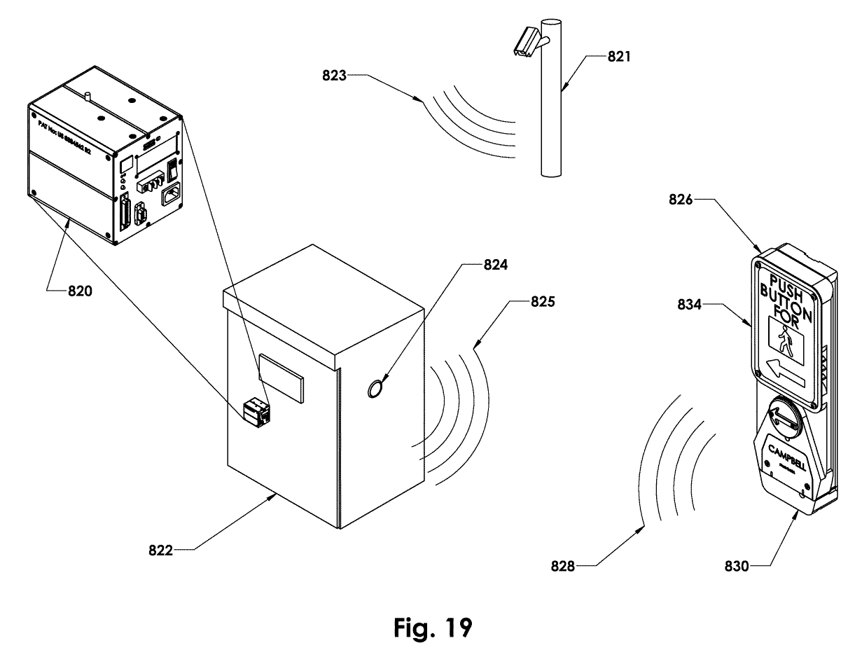

A PCS is generally configured to operate in a base state, a beacon destination state, a standard call state, and an APS call state. Base state operation is illustrated in FIG. 14 and generally begins after PCS initialization. A PCS checks for recent messages (within 250 ms) from the PMU in step 700. If no message has been received, a fault detection procedure is initiated in step 701 (illustrated further in FIG. 18). There is no recovery from this fault process apart from a power-up reset. In step 702, a determination is made as to whether a new message has been received. If a new message has not been received, the PCS returns to step 700 to continue to check for messages. If a new message is received, PCS variables such as those in Tables 4-5 are updated. Typically, each PCS decodes a PMU message to obtain data bits pertinent to an associated crosswalk, and each PCS transmits an acknowledgment to the PMU.

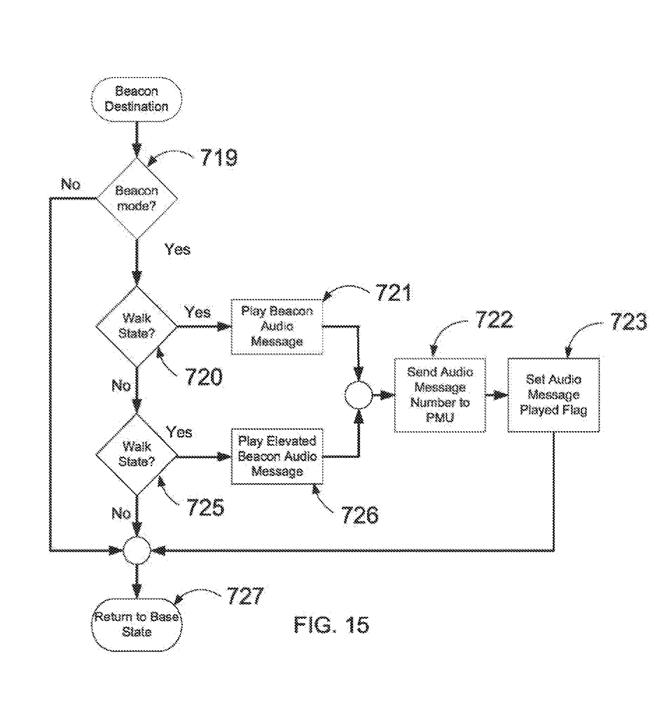

In step 703 day or night mode is selected (or a previous selection confirmed) and normal volume or reduced volume for audio messages is selected in steps 704 and 705. Representative audio messages are listed in Table 6. In a step 706, a bit associated with each PCS of the groupStatusAPSBeaconDestination message is checked. If this bit is checked, a beacon destination process 707 (illustrated in FIG. 15) is initiated. In step 708, a pedestrian call is evaluated to determine if it is a local pedestrian call or an APS pedestrian call.

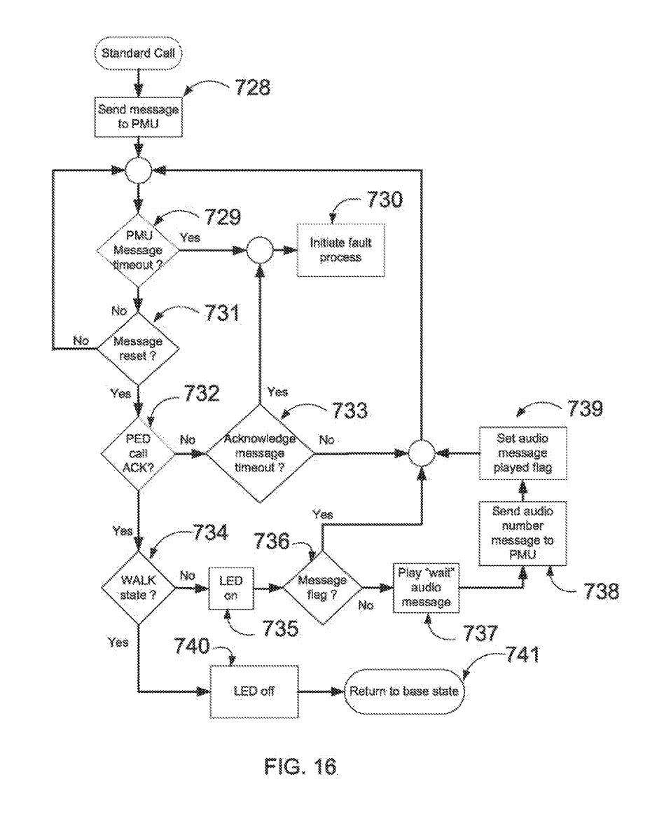

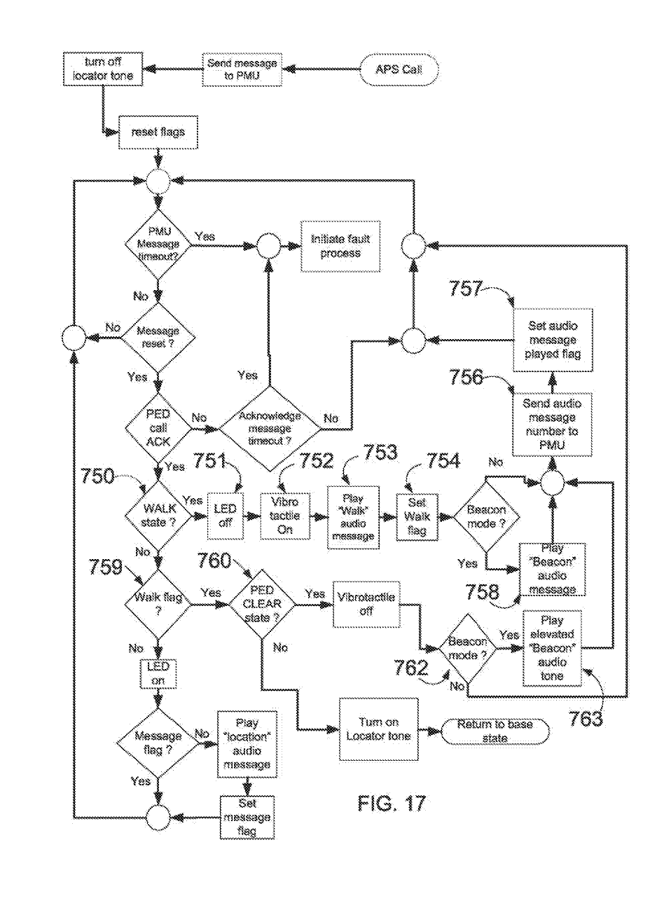

Typically, a duration of a pedestrian button press can be used—a short press (less that about 1-2 s) corresponds to standard pedestrian call and a standard walk sequence 709 (illustrated in FIG. 16) is initiated. In a step 710 a pedestrian call is evaluated to determine if it is an APS pedestrian call. Typically, a button press of greater than about 2 s is associated with an APS call, but press durations for standard and APS calls can be programmed or otherwise set at different values. If an APS call is detected, an APS walk sequence (illustrated in FIG. 17) is initiated. If an APS call is not detected, a PCS bit of the phaseStatusGroupPedestrianCalls message from the PMU is evaluated in a step 712. If a remote call has been detected in the step 712, and the WALK state is active as determined in a step 713, the audio message flag is checked in a step 715. If no audio message is playing, a message is sent to the PMU informing the PMU that no message is playing, and the audio message flag is reset in a step 717. If no audio message has been played, the LED is turned off in a step 718, and the step 700 is repeated. If in a step 713 the WALK state is not active, the LED is turned on and the step 700 is repeated.

A beacon destination process is illustrated in FIG. 15. This process is typically initiated at a PCS that is opposite the PCS from which a call is made, and thus is an intended pedestrian destination. In a step 719, the PCS is checked to determine if it can serve as a beacon. If not, the procedure returns to base state operation in a step 727. If it can provide a beacon, in a step 720 the WALK status of the PCS is checked. If the PCS is in a WALK state, a beacon message is played in a step 721. If a pedestrian clear state is active (provided to warn a pedestrian that a WALK state is nearing completion-a pedestrian clearance phase) as determined in step 725, an elevated volume beacon message in played in step 726. After either beacon audio message is initiated, the PCS periodically sends the audio message number of the message being played to the PMU (at about 1 Hz) in a step 722 and sets an audio message played flag in a step 723. This beacon process continues until the WALK and PED CLEAR bits in the phaseStatusGroup—Walks and the phaseStatusGroupClears variables sent by the PMU to the PCS change, i.e., until the WALK and PED CLEAR intervals have elapsed. If the PMU detects that an incorrect message has been played, an error procedure can be initiated.

FIG. 16 illustrates a standard call process. In a step 728, the PCS sends a message to the PMU indicating that a call has been made at the PCS. The PCS checks that a timeout has not occurred in a step 729. If a timeout has occurred, a fault process 730 (illustrated in FIG. 18) is initiated. In a step 731, the PCS checks for receipt of a new message. If none has been received, the process returns to the step 729. Receipt of a pedestrian call acknowledgment from the PMU is determined in a step 732. If a message has been received but not acknowledged as determined in a step 733, the fault procedure 730 is initiated. The PCS determines if the WALK state is inactive in a step 734, and if so the pedestrian button LED is turned on in a step 735, and a message flag is checked in a step 736. If the WAIT message has not been played based on the message flag, the WAIT message is played in a step 737. In steps 738, 45 739 a message is sent to the PMU that the WAIT message is being played, and an audio message flag is set. If the WAIT message has been played, steps 729, 731, 732, 734, 735, and 736 repeat until the WALK state is active. If the WALK state is active, then the pedestrian button LED is turned off in a step 740, and the call returns to base state operation in a step 741.

FIG. 17 illustrates an APS call sequence. As in other disclosed examples, message receipt between a PMU and a PCS is generally acknowledged. If an acknowledgment is not received, a fault process is initiated. Details of fault processing have been described previously and are not described further herein. As shown in FIG. 17, if an APS call message is generated at a PCS, in a step 750, a determination is made as to whether the PCS is in a WALK state. If so, an indicator LED associated with the PCS is turned off in a step 751, and a vibro-tactile device is turned on in step 752. A WALK message is played in a step 753, and a walk flag is set in a step 754 to indicate that the walk call request has been serviced. If a beacon mode is to be operated, a beacon audio message is played in a step 758, and an audio message identifier is sent to the PMU in a step 756 and an audio message played flag is set in a step 757. If beacon mode is not to be operated, the steps 756, 757 are executed without playing a beacon audio message. If the WALK state is not active, the processor checks for a PED clear state in step 760. Based on this check, the vibro-tactile output is turned off, a beacon mode 762 is entered in which an elevated volume for the beacon audio message is selected in a step 763.

Error processing is illustrated in FIG. 18. If a network communication error is detected in a step 771, all audio outputs are halted in a step 772, and a watchdog timer is started in a step 773. Upon completion of the watchdog time, network operation halts if the error persists. If an acknowledgment error is detected in a step 775, the call message is resent in a step 776 and an error counter is incremented in a step 777. If acknowledgment is received to the resent message in a step 778, operation returns to normal. Otherwise, a series of attempts are made to resend the message, and when the number of errors exceeds a predetermined limit in a step 779, APS operation is disabled in a step 780. If an audio error or a vibro-tactile error is detected in steps 782, 785, an error message is sent to the PMU in a step 784 and APS operation is disabled in the step 780. If an audio error is detected, audio is turned off in the step 783. Additional errors can be detected in a step 786 and communicated to the PMU. Typically, the watchdog timer is initiated and operation halts if the error persists.

FIG. 19 illustrates a preferred embodiment in which components of the system communication via wireless communication wireless communication. The wireless, preferably bi directional, communication occurs between the APC 820 located within the traffic control cabinet 822. The APC can utilize either an integrated receiver, transmitter, and/or transceiver or external receiver, transmitter, and/or transceiver 824 to communication with one or more APBs 826. The APBs include a wireless receiver and a processor positioned within the lower unit 830. The wireless APBs require no wiring other than for power. Power can be supplied from any source including, for example, from the ped head, a battery, a solar panel, or the traffic control cabinet. The APB and APC depicted in FIG. 19 communicate via bi-directional wireless communication 824, 825. Further shown is the optional functionality of the APC to receive a wireless communication 821 providing real-time traffic information from a sensor, such as a camera, at the intersection.

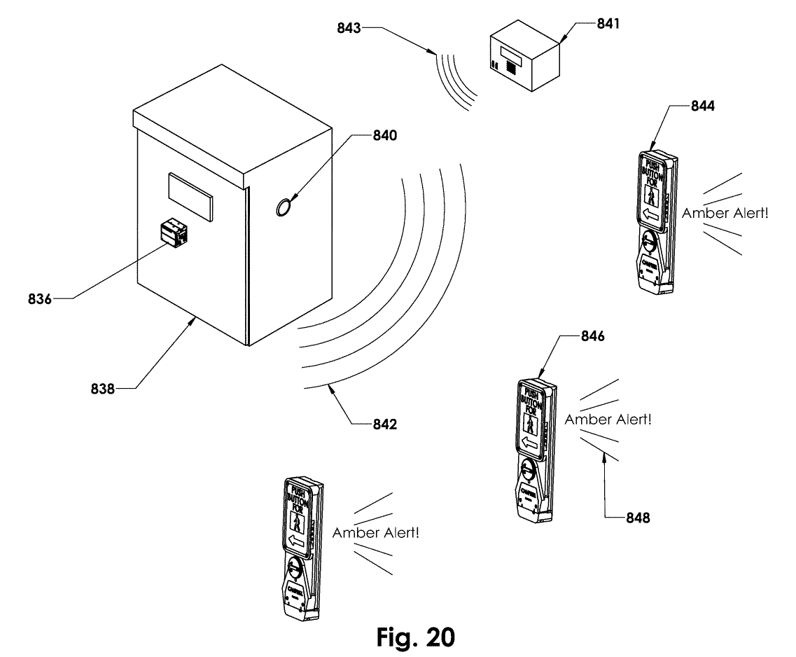

FIG. 20 illustrates a function of APB stations to provide notification of one or more events to pedestrians or other persons located proximate to the APB stations. In the depicted embodiment the APC 836 positioned within the traffic control cabinet 838 receives a transmission, message and/or directive from a central control unit or central authority (841) via wireless communication 843. The APC then utilizes either an integrated receiver, transmitter, and/or transceiver or external receiver, transmitter, and/or transceiver 840 to communicate the message or warning wirelessly 842 with one or more APBs 844, 846. The APBs then either relay the message or directive via an audio signal and/or the APB responds to the transmission, message, and/or directive to determine and emit the proper audio signal 848. The system can respond directly to directives or alternatively be programmed to respond according to the transmission, message, and/or directive received. The system can be utilized to provide notice to a wide variety of situations including emergency situations such as an Amber Alert, a fire, a flood including flash floods, a tornado, a tsunami or any other situation. For example, in a preferred embodiment the APC communicates the information of the Amber Alert to the APB, which in turn broadcasts the information received such as the physical description of the missing child as set forth in the Amber Alert. As a further example, the system could be programmed to notify pedestrians or others in proximity to the APB to seek higher ground in the event of a tsunami or to seek shelter in the event of a tornado.

Additional System Features and Operation

As disclosed in the examples above, WiAAPS configuration and diagnostics can be performed using a PC with a standard web browser and a wireless or wired connection. A web page or series of web pages can provide real-time status of all controller inputs and the state of all pedestrian stations and identify an audio message currently being played. In one example, the system web page provides six tabbed pages: System Status, System Configuration, Time Configuration, Station Settings, File Upload, and View Log Files. The web pages organize data into three types: system operational status, configuration settings, and log files. Status information includes the state of PMU inputs and outputs as well as the state of all PCSs. Configuration settings are organized into two types: system wide and PCS specific settings.

A WiAAPS can include a plurality of traffic control signals (traffic signals), wherein a traffic signal is any highway traffic signal by which traffic is alternately directed to stop and permitted to proceed. Traffic includes pedestrians, bicyclists, ridden or herded animals, vehicles, streetcars, and other conveyances either singularly or together while using any high-way for purposes of travel. A WiAAPScan also include a plurality of Accessible Pedestrian Signals (APSs) that can communicate via wireless communication information about pedestrian timing in non-visual format such as audible tones, verbal messages, and/or vibrations. For low-vision individuals, these audible signals have the same safety and legal implications as illuminated traffic signals. Standard traffic signals can be included as well. An APS can provide three states of operation: Don't Walk (DW), Walk (W), and Flashing Don't Walk (FDW) and in a 35 normal sequence of events when a pedestrian activates the pedestrian button is as follows.

A traffic controller indicates the start of the pedestrian phase by illuminating the Walk signal. After a predetermined time based on the length of the cross walk and the assumed pedestrian walking speed, the 40 pedestrian signal flashes the Don't Walk signal. The FDW interval terminates with a solid Don't Walk signal. For exclusive pedestrian movement operations, the time intervals of the W, FDW and DW intervals are fixed. For pedestrian movement schemes that allow parallel vehicle movement, the mini-45 mum vehicle green time must be no less than the maximum time of the W plus FDW intervals. Pedestrian signal errors can be signaled with a variety of devices including an LCD and/or an LED or array of LEDs at the pedestrian signal while more complete error information is available via the browser-based interface.

A WiAAPS system can use tones of a particular frequency and interval, as well as speech messages. Locator tones are provided to aid pedestrians in finding a button, and beaconing can be used to assist low-vision pedestrians to a destination. The WiAAPS system can communicate via wireless communication pedestrian signal and pedestrian button status from electronics that can be physically located in the pedestrian signal. Power can be obtained from power cables used to power pedestrian displays. The system is configured to conduct data signals using wireless technology. In conventional systems, once signal control lines leave a traffic controller cabinet, there is no feedback from the pedestrian signal other than the amount of load current. If a microprocessor malfunctions and plays an incorrect audible message that indicates a walk signal is on when it is not, then there is a safety hazard. Such conventional systems can be referred to as “unsupervised.” In addition, pedestrian buttons can fail by being permanently open circuited or permanently short circuited. Such a failure is only detectable by public complaint or intersection inspection by maintenance personnel.

In WiAAPS systems, different audio messages can be played depending upon pedestrian signal status and the operation of pedestrian buttons. Bidirectional communications (via wireless in the examples) permits information exchange relating to operating controls and possible failure modes. Each pedestrian button is uniquely distinguishable based on a stored identifier so that beaconing on only one side of an intersection can be used, and audio messages can be stored at the pedestrian button location, or stored elsewhere.

The WiAAPS provides for routing data messaging among system components. Pedestrian signal status for each pedestrian signal can be distributed throughout the WiAAPS, and messages acknowledged. Any PCS that does not respond can be investigated for possible failures, and the WiAAPS can modify traffic control settings so that a safe condition is maintained. Pedestrian signals can include a traffic signal identifier in messages along with an indication of what (if any) audio message or tone is currently being played or has most recently been played. Audio files are transferred to the PMU using HTML multipart/form-data. In this form, the sound file and other fields of the form are packaged and sent to the PMU web host and processed by a common gateway interface (CGI) script. There are five fields sent to the PMU web host: stationid, fileid, resid, the sound file, and the submit field. The stationid field is what PCS has been selected by a user to receive the audio file. Fileid is a number identifying which file is being sent. Resid is a text string used by the AAPMS webpage to notify the user of the status of each file transfer. The submit field is the value of the value of the Submit button that was pressed.

SNMP messages enable the PMU to validate communications with each PCS and each PCS is capable of verifying that a call has been placed to the PMU. For normal operation the PMU periodically generates a SetRequest message that updates each system PCS that in turn returns a GetResponse message to the PMU to verify to the PMU that each PCS is operational and has received the correct information. When a user has pressed a pedestrian button, the PCS sends a Trap message to the PMU. A Trap is an unsolicited message generated by the PCS that the PMU need not respond to. The Trap is verified received on the next received SetRequest. If the next SetResponse message from the PMU does not indicate that a call has been placed, the PCS will generate another Trap.

With the bidirectional communication functionality as described above, traffic control systems can exchange and verify messages of various kinds Messages can be associated with audio message selection and volume, identification of beacon destinations, and detection of unsafe conditions. The description herein provides representative examples, but it should be recognized that the illustrated embodiments are only examples and should not be taken as limiting the scope of the invention. Rather, the scope of the invention is defined by the following claims. We therefore claim as our invention all that comes within the scope and spirit of these claims.

We claim:

1. An advanced accessible pedestrian call system, comprising:
a pedestrian call station configured to be operated by a pedestrian, wherein said pedestrian call station comprises a pedestrian call station switch and a pedestrian call station processor;
a pedestrian management unit, wherein said pedestrian management unit is configured for wireless communication with said pedestrian call station processor; and
wherein said pedestrian call station processor is configured to communicate via wireless communication a traffic control request to said pedestrian management unit in response to activation of the pedestrian call station switch by a pedestrian and to receive via wireless communication an acknowledgement of the traffic control request from the pedestrian management unit, wherein the traffic control request is associated with the controlling of at least one traffic signal so as to allow or deny movement of vehicular traffic.

2. The advanced accessible pedestrian call system of claim 1, further comprising a network interface configured to communicate with the pedestrian call station processor, wherein the network interface is coupled to receive the acknowledgement of the traffic control request from the pedestrian management unit and communicate the traffic control request from the pedestrian station processor to a traffic controller associated with the controlling the at least one traffic signal.

3. The advanced accessible pedestrian call system of claim 1, further comprising a memory, wherein the pedestrian station processor is configured to retrieve at least one audio message from the memory and communicate an identifier associated with the retrieved audio message to the pedestrian management unit.

4. The advanced accessible pedestrian call system of claim 3, wherein the pedestrian station processor is configured to communicate an identifier associated with an audio message volume to the pedestrian management unit.

5. The advanced accessible pedestrian call system of claim 1, wherein the pedestrian station processor is configured to store an audio message received in a memory.

6. The advanced accessible pedestrian call system of claim 1, wherein the pedestrian station processor is operable to adjust an audio message volume and operations based on time of day.

7. The advanced accessible pedestrian call system of claim 1, further comprising a memory coupled to the pedestrian station processor and operable to store audio messages associated with WALK, WAIT, DON'T WALK, destination beacon and additional audio files.

8. The advanced accessible pedestrian call system of claim 7, wherein the pedestrian station processor is operable to set an audio message volume.

9. The advanced accessible pedestrian call system of claim 1, wherein the pedestrian management unit is configured to receive a signal from traffic control sensors to generate requests and actions from the traffic controller.

10. The advanced accessible pedestrian call system of claim 9, wherein said message comprises a notification of an emergency situation.

11. The advanced accessible pedestrian call system of claim 2, wherein said network interface is configured to wirelessly communicate with the pedestrian station processor via wireless communication, wherein the network interface is coupled to receive via wireless communication the acknowledgement of the traffic control request from the pedestrian management unit and communicate via wireless communication the traffic control request from the pedestrian station processor to the traffic controller associated with the controlling the at least one traffic signal.

12. The advanced accessible pedestrian call system of claim 1, wherein the traffic control request is associated with the controlling of at least one traffic signal via wireless communication so as to allow or deny movement of vehicular traffic.

13. The advanced accessible pedestrian call system of claim 1, wherein said pedestrian management unit is configured to wirelessly communicate with at least one traffic sensor configured to sense traffic conditions at said intersection.

14. A advanced accessible pedestrian call system, comprising a pedestrian management processor and a network interface coupled to the pedestrian management processor, wherein the network interface is operable to receive via wireless communication comprising a request for a traffic control service from at least one pedestrian call station of a plurality of pedestrian call stations and to transmit via wireless communication a traffic control request acknowledgement to the at least one pedestrian call station of the plurality of pedestrian call stations, wherein the at least one pedestrian call station of the plurality of pedestrian call stations includes a network interface operable to transmit via wireless communication a signal identifier to the pedestrian management processor.

15. The system of claim 13, wherein the pedestrian management processor is operable to determine a traffic control status associated with a least one traffic control device.

16. The system of claim 13, wherein the network interface is operable to wirelessly communicate traffic control system parameters to the pedestrian management processor.

17. The system of claim 15, wherein the network interface is operable to wirelessly communicate audio message parameters to the pedestrian management processor.

18. The system of claim 13, wherein the network interface is operable to receive via wireless communication a digital audio message and the pedestrian management processor includes a memory configured to store the digital audio message.

19. The system of claim 17, wherein the network interface is operable to transmit wirelessly an audio message identifier to the pedestrian management processor.

20. The system of claim 13, wherein the pedestrian management processor is operable to send wireless communication to a second pedestrian call station via the network interface in response to the request for traffic control service, the communication including an instruction to plan an audible beacon.
